(19) United States
(12) Patent Application Publication
(10) Pub. No.: US 2016/0245924 A1
(43) Pub. Date: Aug. 25, 2016

(54) ELECTRONIC DEVICE AND CONTROL METHOD

(71) Applicant: KYOCERA CORPORATION, Kyoto-shi, Kyoto (JP)

(72) Inventors: Shigeki TANABE, Yokohama-shi, Kanagawa (JP); Hideki MORITA, Yokohama-shi, Kanagawa (JP); Isao MASUIKE, Machida-shi, Tokyo (JP)

(21) Appl. No.: 15/032,311

(22) PCT Filed: Oct. 29, 2014
(86) PCT No.: PCT/JP2014/078822

§ 371 Date: Apr. 27, 2016

(30) Foreign Application Priority Data
Oct. 30, 2013 (JP) 2013-224918

(51) Int. Cl. G01S 19/34; H04W 52/02; G01P 15/18; H04M 1/725

(52) U.S. Cl. CPC G01S 19/34; H04M 1/72522; H04W 52/0251; G01P 15/18; H04M 2250/10; H04M 2250/12

(57) ABSTRACT

An electronic device includes an acceleration sensor for detecting an acceleration, a GPS receiver for receiving a GPS signal, and a controller for determining a type of a stop state or of a moving state based on the acceleration detected by the acceleration sensor and changing a reception period of the GPS signal received by the GPS receiver based on a result of determination.

### FIELD

The present disclosure relates to an electronic device with an acceleration sensor and a control method for the same.

### BACKGROUND

Some of electronic devices can receive a GPS (Global Positioning System) signal.

### SUMMARY

### Technical Problem

The electronic device receives a GPS signal at a constant period.

### Solution to Problem

According to an aspect of the disclosure, there is provided an electronic device comprising: an acceleration sensor configured to detect acceleration; a GPS receiver configured to receive a GPS signal; and a controller configured to determine a stop state or a type of a moving state based on the acceleration detected by the acceleration sensor to change a reception period of the GPS signal received by the GPS receiver based on a result of the determination.

According to another aspect of the disclosure, there is provided a control method for an electronic device including an acceleration sensor and a GPS receiver, the control method comprising: a step of detecting acceleration using the acceleration sensor; a step of receiving a GPS signal using the GPS receiver; a step of determining a stop state or a type of a moving state based on the acceleration detected at the step of detecting acceleration; and a step of changing a period for executing the step of receiving based on a result of a determination at the step of determining.

### Advantageous Effects of Invention

According to the aspects of the invention, a reception period of the GPS signal can be changed.

### BRIEF DESCRIPTION OF DRAWINGS

FIG. 1 is a diagram illustrating a configuration of an electronic device.

FIG. 2 is a diagram schematically illustrating a map application in which an action history is plotted.

### DESCRIPTION OF EMBODIMENTS

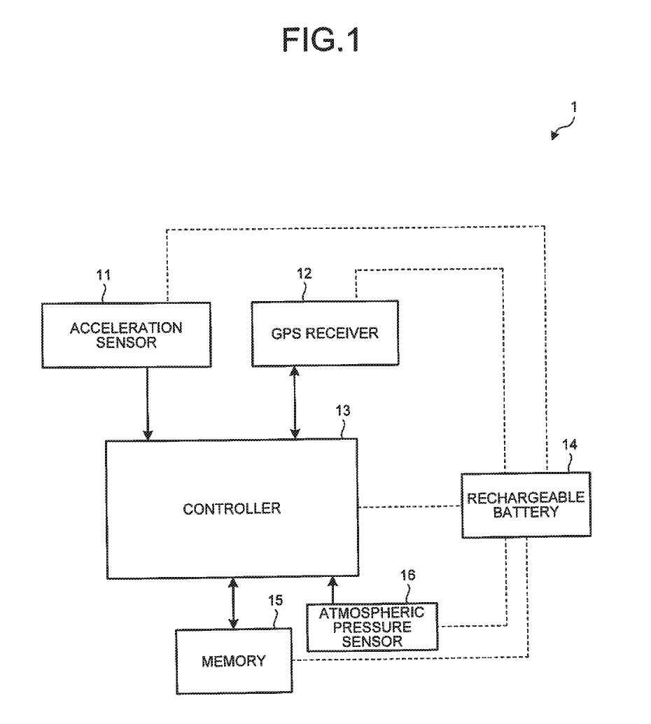

Embodiments of an electronic device and a system will be explained below. FIG. 1 is a block diagram for explaining an embodiment of an electronic device. An electronic device 1 is, for example, a mobile phone, a tablet computer, a pedometer, or a mobile game device.

As illustrated in FIG. 1, the electronic device 1 includes an acceleration sensor 11, a GPS receiver 12, a controller 13, a rechargeable battery 14, a memory 15, and an atmospheric pressure sensor 16. The electronic device 1 is supplied with a power from the rechargeable battery 14, and thereby performs various processing.

The acceleration sensor 11 detects acceleration. The acceleration sensor 11 detects a direction and a magnitude of acceleration applied to the electronic device 1 and outputs a detection result to the controller 13. The acceleration sensor 11 is a 3-axis (three-dimensional) type for detecting accelerations in an X-axis direction, a Y-axis direction, and a Z-axis direction, and measures acceleration (a) based on, for example, force (F) applied from outside of the electronic device 1 and mass (m) of the electronic device 1 (Acceleration (a)=Force (F)/Mass (m)).

The acceleration sensor 11 may be configured as an MEMS (Micro Electro Mechanical Systems) type acceleration sensor using not only a piezoelectric element (piezoelectric type) but also a piezoresistive type, a capacitive type, and a heat-sensitive type; as a servo type acceleration sensor for moving a moving coil and returning it to its original place by a feedback current; and as a strain gauge type acceleration sensor for measuring a strain occurring due to acceleration using a strain gauge, and the like.

The GPS receiver 12 receives a GPS signal. The GPS receiver 12 has a function of receiving a weak high-frequency radio signal (GPS signal), which is pseudo-noise encoded and transmitted from a GPS satellite orbiting around the earth, and a function of accurately measuring position information of its own on the earth by decoding an arrival time of the GPS signal at the ground, time information and a navigation message included in the GPS signal.

The controller 13 determines a “stop state” or a type of a “moving state” based on the acceleration detected by the acceleration sensor 11, and changes a reception period of the GPS signal received by the GPS receiver 12 based on the result of the determination.

The atmospheric pressure sensor 16 detects atmospheric pressure.

A procedure of determining the stop state or the type of the moving state based on the acceleration detected by the acceleration sensor 11 will be explained below.

The acceleration sensor 11 supplies a vector value, as a detection result, obtained by combining the acceleration in the X-axis direction, the acceleration in the Y-axis direction, and the acceleration in the Z-axis direction to the controller 13. The acceleration sensor 11 may supply, instead of the combined vector value, the acceleration in the X-axis direction, the acceleration in the Y-axis direction, and the acceleration in the Z-axis direction to the controller 13 without any change. In the case of this configuration, the controller 13 combines the acceleration in the X-axis direction, the acceleration in the Y-axis direction, and the acceleration in the Z-axis direction to calculate a combined vector value.

The controller 13 logs the combined vector value, analyses the logged data, and determines the status of the electronic device 1. For example, the controller 13 compares the result of analyzing the logged data and sample data indicating a plurality of moving states stored in the memory 15, and determines a user's stop state or the type of a user's moving state.

The user's moving state includes, for example, a walking state, a running state, a moving state by bicycle, and a moving state by vehicle. “Walking state” is a state in which the user of the electronic device 1 is moving on foot. “Running state” is a state in which the user of the electronic device 1 is moving at a run. “Moving state by bicycle” is a state in which the user of the electronic device 1 is moving by bicycle. “Moving state by vehicle” is a state in which the user of the electronic device 1 is moving by any vehicle other than the bicycle. In other words, the user's moving state indicates how to move when the user moves.

The electronic device 1 appropriately changes the reception period of the GPS signal received by the GPS receiver 12 based on the result of determining the stop state or the type of the moving state, and therefore power consumption due to the GPS receiver 12 can be reduced, which results in reduction of the power consumption of the entire device.

When the result of the determination by the controller 13 is the stop state based on the acceleration detected by the acceleration sensor 11, the controller 13 may be configured to change the reception period of the GPS signal by stopping the drive of the GPS receiver 12.

Thus, the electronic device 1 stops the drive of the GPS receiver 12 in the case of the stop state, and, therefore, the power consumption due to the GPS receiver 12 is not occurred, which makes it possible to reduce the power consumption of the entire device.

When the result of the determination by the controller 13 is the stop state based on the acceleration detected by the acceleration sensor 11, the controller 13 may be configured to change the reception period of the GPS signal by stopping the operation of receiving the GPS signal at the GPS receiver 12.

Thus, the electronic device 1 stops the operation of receiving the GPS signal at the GPS receiver 12 in the case of the stop state, and, therefore, the power consumption due to the operation of receiving the GPS signal at the GPS receiver 12 is not occurred, which makes it possible to reduce the power consumption of the device.

The electronic device 1 has a function of calculating a current location based on the GPS signal received by the GPS receiver 12 and plotting the current location on a map displayed by map application. The user can confirm the current location by viewing the map on which the current location is plotted, and can also confirm a moving route by viewing the plotted history.

When the type of the moving state is determined based on the acceleration detected by the acceleration sensor 11, the controller 13 may be configured to change the reception period of the GPS signal according to the determined type of movement. The moving state includes, as explained above, the walking state, the running state, the moving state by bicycle, the moving state by vehicle, and the like.

When it is recognized that the type of the moving state is the walking state based on the acceleration detected by the acceleration sensor 11, the electronic device 1 calculates a walking distance by calculating a stride and the number of steps based on the detected acceleration. The electronic device 1 may calculate a walking distance with the preset stride and the number of steps calculated based on the detected acceleration.

When it is recognized that the type of the moving state is the running state based on the acceleration detected by the acceleration sensor 11, the electronic device 1 calculates a running distance by calculating a stride and the number of steps in running based on the detected acceleration. The electronic device 1 may calculate a running distance with the preset stride in running and the number of steps calculated based on the detected acceleration.

When it is recognized that the type of the moving state is the moving state by bicycle based on the acceleration detected by the acceleration sensor 11, the electronic device 1 calculates a running distance of the bicycle. The electronic device 1 calculates the running distance of the bicycle by using, for example, the acceleration detected by the acceleration sensor 11, the current location measured by using the GPS signal received by the GPS receiver 12, and the map data.

A case where the type of the moving state is the moving state by vehicle will be explained below. In the following, the vehicle other than the bicycle is assumed as a car; however, the vehicle is not limited thereto. When it is recognized that the type of the moving state is the state of being in a car (the moving state by vehicle) based on the acceleration detected by the acceleration sensor 11, the electronic device 1 calculates a travel distance of the car. The electronic device 1 calculates the travel distance of the car by using, for example, the acceleration detected by the acceleration sensor 11, the current location measured by using the GPS signal received by the GPS receiver 12, and the map data.

The controller 13 controls the reception period of the GPS signal received by the GPS receiver 12 so as to receive the GPS signal, for example, for each 10 m of the moving of the user regardless of the types of the moving state. The moving distance is not limited to 10 m, and any other value may be adopted.

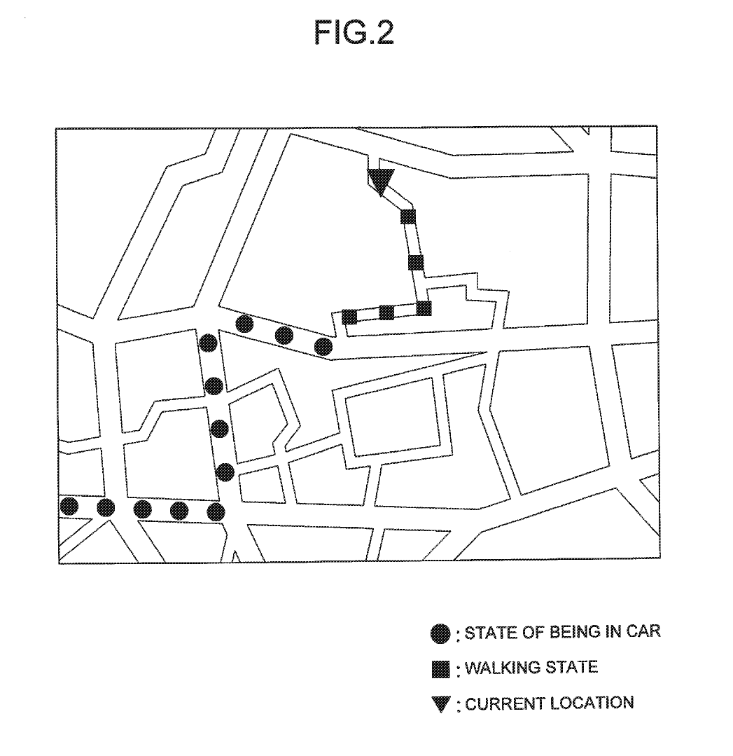

According to this configuration, for example, when the user moves by vehicle and then moves on foot, the electronic device 1 is configured to display the route on the map application in such a manner that the interval between the plotted points is substantially equal as illustrated in FIG. 2. If the GPS signals are received at the same period in the movement by vehicle and in the movement on foot, the interval between the plotted points becomes non-uniform.

Thus, the electronic device 1 reduces the frequency of intermittently reception of the GPS signal in the case of the movement at a slow speed such as walking, and the number of operations of the GPS receiver 12 can thereby be reduced according to the moving state, which makes it possible to reduce the power consumption. The frequency of intermittently receiving the GPS signal does not need to be changed based on an actual moving speed of the user but may be changed based on a moving speed assumed in each of the moving states.

When the place where the user is now moving is a road and legal speed information can be acquired from the map application etc., the electronic device 1 may determine the intermittently reception period of the GPS signal based on the information. When the fact that the place where the user is currently moving is an expressway can be acquired from the map application etc., the electronic device 1 may determine the intermittently reception period of the GPS signal based on speed limit information of the expressway.

The operation of the electronic device 1 in the moving state by using stairs or by using an elevator will be explained next.

Atmospheric-pressure is measured by the atmospheric pressure sensor 16, which enables the electronic device 1 to detect an altitude or a change in the altitude, and to determine whether the type of the moving state is the moving state by using stairs or the moving state by using an elevator based on the result of the detection.

The movement using stairs or an elevator is generally a vertical movement. When such a movement is plotted on a map (two-dimension) displayed two-dimensionally (plane), plotted points are concentrated at a location of the stairs or the elevator.

Therefore, the electronic device 1 controls so as not to receive the GPS signal in the movement area with the stairs or with the elevator in the same manner such as the stop state.

According to this configuration, since the electronic device 1 controls so as not to receive the GPS signal in the movement using the stairs or the elevator, it is possible to suppress the number of operations of the GPS receiver 12, to reduce the power consumption, and not to partially concentrate the points to be plotted on the map.

The electronic device 1 may be configured to reduce the power consumption by controlling so as not to calculate the current location based on the received GPS signal even if the GPS receiver 12 receives the GPS signal during the movement using the stairs or the elevator.

The operation of the electronic device 1 when the user is moving along a sloping road will be explained next.

The electronic device 1 can determine a slope of a moving environment, i.e., whether the moving environment is a level road, an upward slope, or a downward slope based on the detection results of the acceleration sensor 11 and the atmospheric pressure sensor 16.

The electronic device 1 may be configured to appropriately change the reception period of the GPS signal received by the GPS receiver 12 according to the determined moving environment.

In general, the moving speed tends to increase in the order, such as the upward slope<level road<downward slope, even if the user intends to keep the moving speed constant.

The electronic device 1 determines whether the moving environment is the level road, the upward slope, or the downward slope based on the acceleration detected by the acceleration sensor 11 and log information of a height difference detected by the atmospheric pressure sensor 16, and controls so that the reception period of the GPS signal received by the GPS receiver 12 becomes longer in the order, such as the downward slope<level road<upward slope. In other words, the electronic device 1 controls so that the slower the moving speed is, the longer the reception period becomes.

According to this configuration, the electronic device 1 can plot highly accurate position information in the map application even in any moving environment because the number of operations of the GPS receiver 12 is changed according to the moving environment. Furthermore, the electronic device 1 can reduce the power consumption because the operation of the GPS receiver 12 at an unnecessary timing can be reduced.

Although the present embodiment has explained the configuration and the operations of the electronic device 1 that reduces the power consumption, the embodiments are not limited thereto. The electronic device 1 may be configured so as to implement the operation for reducing power consumption by the program.

The operation may be implemented by recording the program for implementing the functions of the electronic device 1 in a computer-readable non-transitory recording medium, reading the program recorded in the recording medium into a computer system, and executing the program.

“Computer system” mentioned here includes an OS and hardware such as peripheral devices. Moreover, “computer-readable non-transitory recording medium” indicates a portable medium such as a flexible disk, a magneto-optical disk, a ROM, an optical disk (CD, DVD, and Blu-ray (registered trademark), etc.), a memory card, and a USB disk; and a storage device such as a hard disk drive and a solid state drive built into the computer system.

The program for implementing the functions of the electronic device 1 may be stored in a computer-readable recording medium. “Computer-readable recording medium” may include those that dynamically store a program for a short period of time like a communication wire used when the program is transmitted through a network such as the Internet and a communication line such as a telephone line and those that store a program for a given period of time like a volatile memory inside the computer system that functions as a server and a client in that case. The program may be those for implementing part of the functions and those that can further implement the functions in combination with the program already stored in the computer system.

### REFERENCE SIGNS LIST

1 ELECTRONIC DEVICE
11 ACCELERATION SENSOR
12 GPS RECEIVER
13 CONTROLLER
14 RECHARGEABLE BATTERY
15 MEMORY
16 ATMOSPHERIC PRESSURE SENSOR

1-9. (canceled)

10. An electronic device comprising:
an acceleration sensor configured to detect acceleration thereof;
a GPS receiver configured to receive a GPS signal; and
a controller configured to change a reception period of the GPS signal received by the GPS receiver based on the acceleration detected by the acceleration sensor.

11. The electronic device according to claim 10, wherein
the controller is configured to
determine a first state of a user based on the acceleration detected by the acceleration sensor, and
change the reception period when the first state is determined.

12. The electronic device according to claim 11, wherein
the first state composes a stop state.

13. The electronic device according to claim 11, wherein
the first state composes a state of not a moving state.

14. The electronic device according to claim 13, wherein
the moving state composes a walking state, a running state, a moving state by bicycle and a moving state by vehicle.

15. The electronic device according to claim 10, wherein
the controller is configured to
determine a second state of the user based on the acceleration detected by the acceleration sensor, and
change the reception period when the second state is determined.

16. The electronic device according to claim 15, wherein
the second state composes at least one of a walking state, a running state, a moving state by bicycle and a moving state by vehicle.

17. The electronic device according to claim 10, wherein
the controller is configured to
determine a second state of the user based on the acceleration detected by the acceleration sensor,
set the reception period to a first period when the first state is determined, and
set the reception period to a second period when the second state is determined.

18. The electronic device according to claim 10, wherein,
when the first state is determined,
the controller is configured to change the reception period by stopping drive of the GPS receiver.

19. The electronic device according to claim 10, wherein,
when the first state is determined,
the controller is configured to change the reception period by stopping an operation of receiving the GPS signal at the GPS receiver.

20. The electronic device according to claim 15, wherein,
the controller is configured to
measure a moving distance of the user after the second state has been determined,
change the reception period by causing the GPS receiver to perform an operation of receiving the GPS signal based on the distance.

21. The electronic device according to claim 20 wherein,
the second state composes a moving state.

22. The electronic device according to claim 20 wherein,
the controller is configured to measure the moving distance of the user based on the GPS signal received by the GPS receiver.

23. The electronic device according to claim 10, further comprising:
an atmospheric pressure sensor configured to detect atmospheric pressure, wherein,
the controller is configured to change the reception period further based on the atmospheric pressure detected by the atmospheric pressure sensor.

24. The electronic device according to claim 15, further comprising:
an atmospheric pressure sensor configured to detect atmospheric pressure, wherein,
the controller is configured to
determine a vertical moving of the user based on a change in the atmospheric pressure when the second state is determined,
change the reception period based on the vertical moving.

25. The electronic device according to claim 24, wherein,
the second state composes a moving state.

26. The electronic device according to claim 24, wherein,
the controller is configured to change the reception period by stopping drive of the GPS receiver when the vertical moving is determined.

27. The electronic device according to claim 24, wherein,
the controller is configured to change the reception period by stopping an operation of receiving the GPS signal at the GPS receiver when the vertical moving is determined.

28. The electronic device according to claim 10, further comprising:
an atmospheric pressure sensor configured to detect atmospheric pressure, wherein
the controller is configured to
determine a moving environment according to the second state based on the acceleration detected by the acceleration sensor and the atmospheric pressure detected by the atmospheric pressure sensor when the second state is determined, and
change the reception period according to the moving environment.

29. A control method for an electronic device including an acceleration sensor and a GPS receiver, the control method comprising:
a step of detecting acceleration using the acceleration sensor;
a step of receiving a GPS signal using the GPS receiver; and
a step of changing a period for executing the step of receiving based on the acceleration.
